(19) United States
(12) Patent Application Publication
(10) Pub. No.: US 2017/0374673 A1
(43) Pub. Date: Dec. 28, 2017

(54) RADIO DEVICE, BASE STATION, AND TERMINAL DEVICE

(71) Applicant: FUJITSU LIMITED, Kawasaki-shi (JP)

(72) Inventors: Noboru Hasegawa, Oota (JP); TAKESHI KUNUGI, Yokohama (JP); Kazunari Kobayashi, Yokohama (JP); Satoshi Ueda, Yokohama (JP); YOSHIO MIURA, Yokohama (JP); Katsuyuki Masuda, Yokohama (JP); Yuya Murakami, Yokohama (JP); Takeshi YONEKURA, Kawasaki (JP); YOSHIO TAMURA, Yokohama (JP); Michiaki MORI, Yokohama (JP); Koki TAKAHASHI, Chofu (JP)

(73) Assignee: FUJITSU LIMITED, Kawasaki-shi (JP)

(21) Appl. No.: 15/600,309

(22) Filed: May 19, 2017

(30) Foreign Application Priority Data
Jun. 24, 2016 (JP) 2016-126048

(51) Int. Cl. H04W 72/10; H04W 72/04

(52) U.S. Cl. CPC H04W 72/10; H04W 72/0453

(57) ABSTRACT

An RRH includes an extracting unit, an urgent information processing unit, an inserting unit, and a transmitting unit. The extracting unit extracts a resource block, from among resource blocks included in a signal received from a terminal device, that is previously allocated for transmission of urgent information. When the urgent information is included in the resource block extracted by the extracting unit, the urgent information processing unit creates report information including the urgent information that is included in the resource block extracted by the extracting unit. The inserting unit inserts the report information including the urgent information created by the urgent information processing unit into the resource block that is previously allocated for a report of the urgent information.

### CROSS-REFERENCE TO RELATED APPLICATION

This application is based upon and claims the benefit of priority of the prior Japanese Patent Application No. 2016-126048, filed on Jun. 24, 2016, the entire contents of which are incorporated herein by reference.

### FIELD

The embodiment discussed herein is related to a radio device, a base station, and a terminal device.

### BACKGROUND

In recent years, for automated driving of vehicles, there is a proposed assist function in which various kinds of sensors are installed in vehicles and driving of the vehicles is assisted based on the information acquired by the sensors. As the assist function, for example, there is an automatic brake system, or the like. Furthermore, there is a proposed technology that makes good use of driving by collecting information on each of the vehicles, such as driving information acquired by the sensors, or the like, in a data server via a radio communication network and by feeding back information that is used to assist the driving to each of the vehicles. An example of information that is used to assist the driving includes, for example, congestion information on the road on which a vehicle is running, construction information, or the like.

Furthermore, it is possible to perform control of selecting the route of the destination based on a global positioning system (GPS) signal or map information and control of, during the vehicle being moving, not only an automatic brake but also a steering wheel operation or an accelerator movement based on the information from sensors mounted on the vehicles. In this way, researches and developments have been promoted in order to implement automated operation in a single vehicle. However, in order for a single vehicle to perform a complete automated operation efficiently, it is preferable to perform analysis and determination including information, such as information on other vehicles or traffic situations of the surroundings, in addition to the information that can be collected by the single vehicle using various kinds of sensors. A lot of communication methods of communication between vehicles and road-to-vehicle communication are proposed. However, for the complete automated operation, in order to share information and to feed back the information to the vehicles, it is desirable to perform communication in real time to share information on a large number of vehicles.

Conventionally, if information from a certain terminal device belonging to a radio communication system is shared and used with the other terminal devices, in general, data is collected to a dedicated data server and the information is distributed to each of the terminal devices. Furthermore, as another method of sharing information, there is a method that implements broadcasting between terminal devices by repeating one-to-one direct communication between the terminal devices without using a radio communication system network. Prior art examples are disclosed in International Publication Pamphlet No. WO 2015/046155 and Japanese Laid-open Patent Publication No. 2015-50529.

However, when information is shared among a plurality of terminal devices via the data server, a transmission delay is increased because the information is transmitted via a plurality of devices included in the communication network. Thus, if information that is output from a terminal device to another vehicle via the data server, it is difficult to improve the performance of the automated operation of the vehicle. Furthermore, because a communication range is small in one-to-one direct communication between the terminal devices, in order to transmit the information to a distant vehicle, a transmission delay becomes large because one-to-one direct communication is repeated. Consequently, even if one-to-one direct communication is used between the terminal devices, it is also difficult to improve the performance of the automated operation. In this way, in a case of passing through the data server or repeating one-to-one direct communication, it is difficult to transmit information having high urgency, such as information that is used to the automated operation of the vehicle, in a low delay.

### SUMMARY

According to an aspect of an embodiment, a radio device used in a base station that includes the radio device and a radio control device, the radio device includes an extracting unit, an urgent information processing unit, and an inserting unit. The extracting unit extracts a resource block, from among resource blocks included in a signal received from a terminal device, that is previously allocated for transmission of urgent information. The urgent information processing unit that creates, when the urgent information is included in the resource block extracted by the extracting unit, report information including the urgent information that is included in the resource block extracted by the extracting unit. The inserting unit that inserts the report information including the urgent information created by the urgent information processing unit into a resource block that is previously allocated for a report of the urgent information.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 is a schematic diagram illustrating an example of a radio communication system;

FIG. 2 is a block diagram illustrating an example of a base band unit (BBU);

FIG. 3 is a block diagram illustrating an example of a remote radio head (RRH);

FIG. 4 is a schematic diagram illustrating an example of arrangement of a physical channel in the uplink;

FIG. 5 is a schematic diagram illustrating an example of a reservation area in detail;

FIG. 6 is a schematic diagram illustrating an example of urgent information;

FIG. 7 is a schematic diagram illustrating an example of arrangement of a physical channel in the downlink;

FIG. 8 is a block diagram illustrating an example of a terminal device;

FIG. 9 is a sequence diagram illustrating an example of a process performed in the radio communication system;

FIG. 10 is a sequence diagram illustrating an example of a process performed in the terminal device when the urgent information is transmitted;

FIG. 11 is a sequence diagram illustrating an example of a process performed in the terminal device when the urgent information is received;

FIG. 12 is a sequence diagram illustrating an example of a process performed in the radio communication system when a collision occurs in urgent information;

FIG. 13 is a schematic diagram illustrating an example of hardware of the BBU;

FIG. 14 is a schematic diagram illustrating an example of hardware of the RRH; and

FIG. 15 is a schematic diagram illustrating an example of hardware of the terminal device.

### DESCRIPTION OF EMBODIMENTS

Preferred embodiments of the present invention will be explained with reference to accompanying drawings. Furthermore, the radio device, the base station, and the terminal device disclosed in the present application are not limited to the embodiments below.

Configuration of a Radio Communication System 1

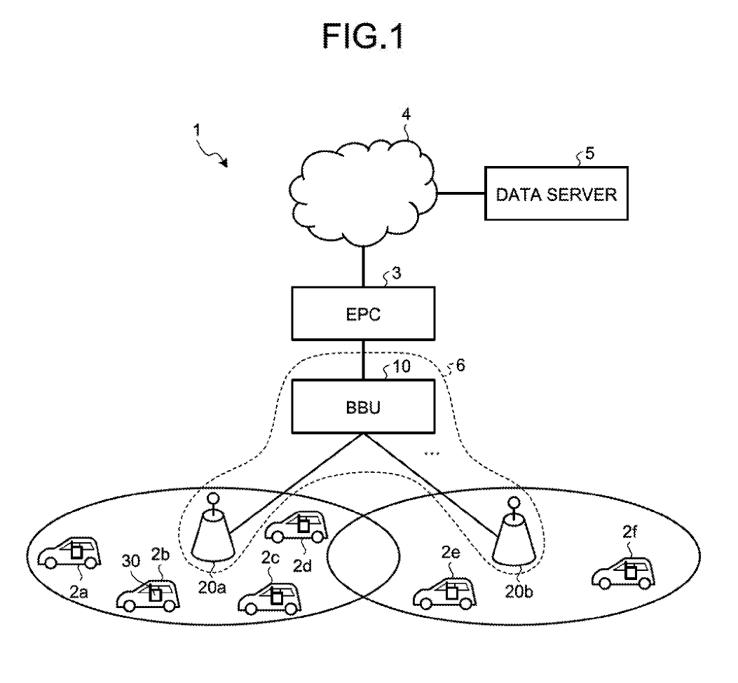

FIG. 1 is a schematic diagram illustrating an example of a radio communication system 1. The radio communication system 1 according to the embodiment includes an evolved packet core (EPC) 3, a communication network 4, a data server 5, and a base station 6. The base station 6 includes a BBU 10 and a plurality of RRHs 20a and 20b. The base station 6 provides a service of voice communication or data communication based on the communication standard, such as Long Term Evolution (LTE), or the like. The BBU 10 is connected to the communication network 4, such as the Internet, or the like, via the EPC 3. Each of the plurality of the RRHs 20a and 20b is connected to the BBU 10 via a cable, such as optical fibers, or the like.

Furthermore, in a description below, if there is no need to distinguish among each of the plurality of the RRHs 20a and 20b, the RRHs 20a and 20b are simply referred to as a RRH 20. Furthermore, in FIG. 1, the single base station 6 is connected to the EPC 3; however, two or more of the base stations 6 may also be connected to the EPC 3. Furthermore, in FIG. 1, the two RRHs 20 are connected to the single BBU 10; however, the single RRH 20 may also be connected to the single BBU 10 or three or more of the RRHs 20 may also be connected. The BBU 10 is an example of a radio control device and each of the RRHs 20 is an example of radio device.

The EPC 3 has a role of an interface with the BBU 10 in a core network. Furthermore, the EPC 3 is connected to the communication network 4 and performs communication with the data server 5 via the communication network 4. The EPC 3 includes, for example, Mobility Management Entity (MME), S-GW (Serving Gateway), Packet Data Network Gateway (P-GW), Policy and Charging Rules Function (PCRF), or the like.

The RRH 20a performs radio communication with a terminal device 30 mounted on each of vehicles 2a to 2d that are present in a cell. The RRH 20b performs radio communication with the terminal device 30 mounted on each of the vehicles 2e to 2f that are present in a cell. Furthermore, in a description below, if there is no need to distinguish among each of the vehicles 2a to 2f, the vehicles 2a to 2f are simply referred to as a vehicle 2. Furthermore, the number of the vehicles 2 present in the cell of each of the RRHs 20 is not limited to the number illustrated in FIG. 1.

The BBU 10 performs communication, via each of the RRHs 20, with the terminal devices 30 mounted on the vehicles 2 present in the cells of the RRH 20 and performs communication with the data server 5 via both the EPC 3 and the communication network 4. Furthermore, the BBU 10 may also perform communication with the other BBU 10 via the EPC 3 or via an intra-base station communication interface provided in the BBU 10.

The terminal device 30 is mounted on each of the vehicles 2. The terminal devices 30 mounted on the vehicles 2 perform, in the cells of the respective RRHs 20, radio communication with the RRHs 20 and perform communication with the BBU 10 via the respective RRHs 20. Then, each of the terminal devices 30 performs communication with the other terminal device 30 or the data server 5 via the BBU 10.

Here, if the terminal device 30 mounted on the vehicle 2 (for example, vehicle 2a) included in the cell detects the occurrence of information having high urgency (hereinafter, referred to as “urgent information”), such as information used for autonomous control of the vehicle 2, or the like, the terminal device 30 conveys the urgent information to the terminal devices 30 mounted on the other vehicles 2 (for example, the vehicles 2b to 2d). For example, if the urgent information is conveyed via the data server 5 that is connected to the communication network 4, a transmission delay or fluctuation of transfer time occurs in both the EPC 3 and the communication network 4. Furthermore, if the urgent information is conveyed due to the repetition of one-to-one direct communication, the urgent information transmitted from the terminal device 30 mounted on, for example, the vehicle 2a is transferred by each of the terminal devices 30 mounted on the vehicles 2b and 2c and delivered to the terminal device 30 mounted on the vehicle 2d. In this case, a delay occurs due to transfers performed twice.

In contrast, in the embodiment, the RRH 20 detects the urgent information sent from the terminal device 30 mounted on the vehicle 2 in the cell; reloads, in the RRH 20, the detected urgent information to a downlink transmission signal; and reports to the terminal device 30 mounted on each of the vehicles 2 included in the cells. Consequently, the urgent information transmitted from the terminal device 30 mounted on the vehicle 2 in the cell is conveyed to all of the terminal devices 30 mounted on the vehicles 2 in the cells at a single transfer. Consequently, the RRH 20 according to the embodiment can convey the information that has high urgency and that is transmitted from the certain terminal device 30 to the other terminal devices 30 in a low delay.

Furthermore, the RRH 20 according to the embodiment can be implemented by adding functions to the RRHs that are arranged in a wide area in a distributed manner in order to provide a service of voice communication or a service of data communication based on, for example, the communication standard, such as LTE, or the like. Thus, if the RRHs 20 according to the embodiment are used, it is possible to provide a low delay transmission service of urgent information to a wider area at lower cost when compared in a case of newly arranging a dedicated base station in order to transmit the urgent information in a low delay.

BBU 10

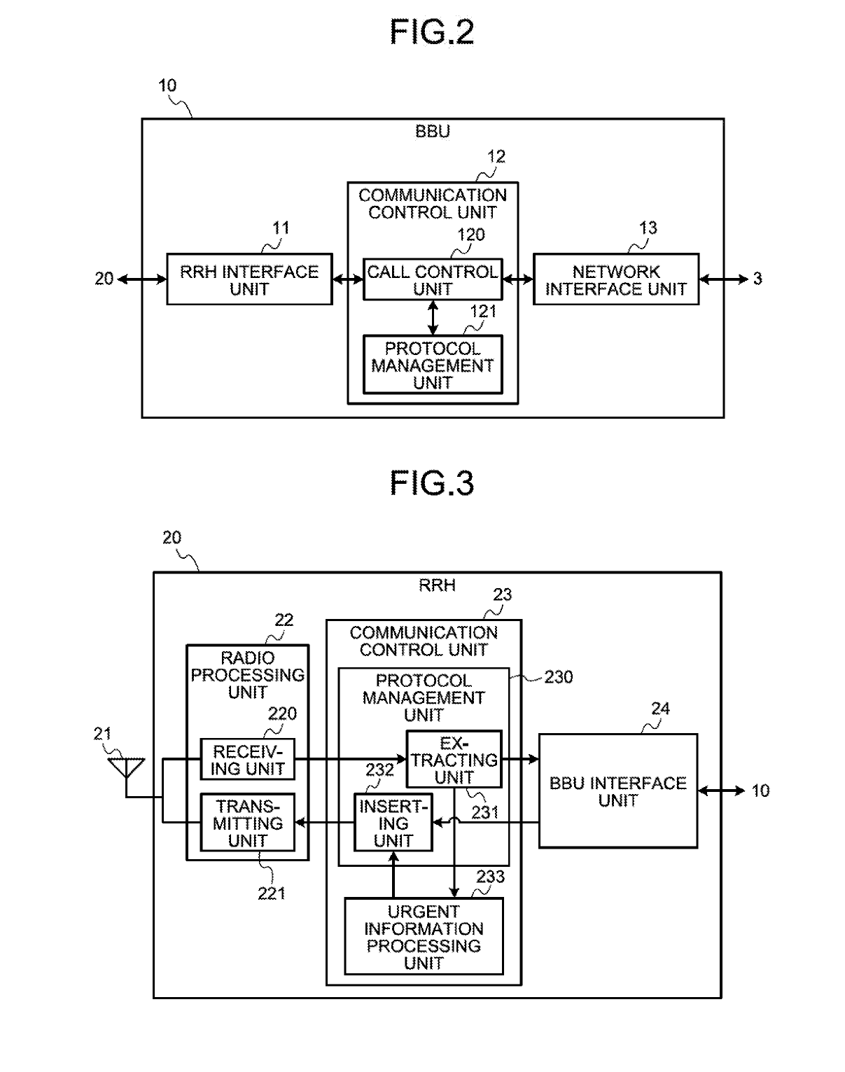

FIG. 2 is a block diagram illustrating an example of the BBU 10. The BBU 10 according to the embodiment includes, for example, as illustrated in FIG. 2, a RRH interface unit 11, a communication control unit 12, and a network interface unit 13.

The RRH interface unit 11 is an interface for performing wired communication with each of the RRHs 20. The RRH interface unit 11 performs communication with each of the RRHs 20 via a cable, such as optical fibers, or the like, by using an optical signal based on, for example, the communication standard, such as the Common Public Radio Interface (CPRI), or the like. The network interface unit 13 is an interface for performing wired communication with the EPC 3.

The communication control unit 12 includes a call control unit 120 and a protocol management unit 121. The call control unit 120 performs, by using previously set call setting, overall control of a call process related to radio communication or voice communication, such as control of the communication resources that are used for the communication with the terminal devices 30. For example, the call control unit 120 performs a process to be performed in a layer 1 to a layer 3 between the terminal devices 30 via each of the RRHs 20. An example of the process performed in the layer 1 includes, for example, demodulation or decoding of the signal received from the terminal device 30, encoding or modulation of the signal transmitted to the terminal device 30, mapping of resource blocks, or the like. Furthermore, an example of the process performed in a layer 2 includes, for example, control of retransmission, data compression, or the like. Furthermore, an example of the process performed in the layer 3 includes, for example, a process related to a handover of the terminal devices 30, a process related to a measurement report from the terminal device 30, management of a Radio Resource Control (RRC) connection, or the like.

The call control unit 120 performs the processes to be performed in the layer 1 to the layer 3 on the signal transmitted from the terminal device 30 via the RRH interface unit 11 and then outputs the processed signal to the network interface unit 13. Furthermore, the call control unit 120 performs the processes to be performed in the layer 1 to the layer 3 on the signal transmitted from the data server 5, the other BBU 10, or the like via the EPC 3 and then outputs the processed signal to the RRH interface unit 11.

Furthermore, the call control unit 120 manages, for each of the RRHs 20, the information on the terminal devices 30 that are included in the cell of the respective RRHs 20. Then, the call control unit 120 allocates, for each of the RRHs 20, each of the plurality of the resource blocks that are previously allocated, in the uplink, for transmission of the urgent information to each of the terminal devices 30 in the cell of the respective RRHs 20. The resource block is the radio resource specified for each combination of the time zone and the frequency band. In the embodiment, for each uplink subframe, a plurality of resource blocks that are to be used for transmission of urgent information is previously allocated.

The call control unit 120 allocates, in each of the subframes, for each of the RRHs 20, the resource blocks that are used for transmission of urgent information by the terminal devices 30 included in the cell of the respective RRHs 20 to each of the terminal devices 30 such that the number of terminal devices 30 allocated to the same resource block can be reduced. Consequently, it is possible to prevent the same resource block from being used for the transmission of the urgent information by the plurality of the terminal devices 30. The information related to the allocation of the resource blocks is sent, as a notification, to each of the terminal devices 30 by using a downlink control channel.

When establishing a connection between the terminal devices 30, the protocol management unit 121 determines the content of the signal received from the terminal device 30. Then, the protocol management unit 121 performs a process of generating a signal or the like in accordance with the protocol corresponding to the content of the determined signal. For example, in response to the signal transmitted from the terminal device 30, the protocol management unit 121 generates, in a random access procedure, a signal of RACH response, RRC connection setup, or the like and then outputs the generated signal to the call control unit 120.

RRH 20

FIG. 3 is a block diagram illustrating an example of the RRH 20. The RRH 20 includes, for example, as illustrated in FIG. 3, an antenna 21, a radio processing unit 22, a communication control unit 23, and a BBU interface unit 24. The BBU interface unit 24 is an interface for performing wired communication with the BBU 10. The BBU interface unit 24 performs communication with the BBU 10 via a cable, such as optical fibers, or the like, by using an optical signal based on the communication standard, such as CPRI, or the like.

The radio processing unit 22 includes a receiving unit 220 and a transmitting unit 221. The receiving unit 220 receives the radio signal output from the terminal device 30 via the antenna 21. Then, the receiving unit 220 generates a baseband reception signal by performing a process of amplification, down-conversion, and the like on the received signal. Then, the receiving unit 220 outputs the generated baseband reception signal to the communication control unit 23.

The transmitting unit 221 generates a signal having a radio frequency (RF) band by performing a process of up-conversion, amplification, and the like on the baseband transmission signal that is output from the communication control unit 23. Then, the transmitting unit 221 transmits the generated signal having the RF band to the terminal device 30 via the antenna 21.

The communication control unit 23 includes a protocol management unit 230 and an urgent information processing unit 233. The protocol management unit 230 includes an extracting unit 231 and an inserting unit 232. The extracting unit 231 performs Fourier transformation on the signal received from the terminal device 30. Then, the extracting unit 231 extracts a resource block that is previously allocated for transmission of urgent information from among the resource blocks included in the signal that has been subjected to Fourier transformation. Then, the extracting unit 231 outputs the extracted resource block for the transmission of the urgent information to the urgent information processing unit 233.

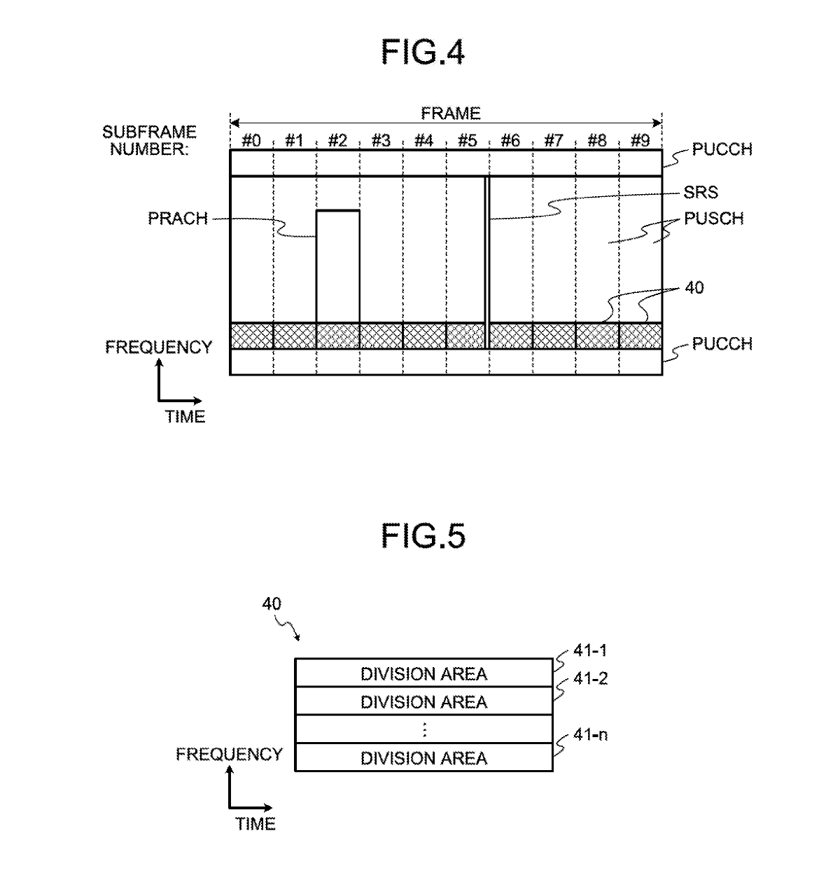

In the following, an uplink physical channel transmitted from the terminal device 30 will be described. FIG. 4 is a schematic diagram illustrating an example of arrangement of a physical channel in the uplink. In the uplink, for example, as illustrated in FIG. 4, a single frame is constituted by a plurality of subframes in the time direction. In the embodiment, 10 subframes with the frame numbers of #0 to #9 are included in a single frame. The length of the single frame is, for example, 10 milliseconds and the length of each of the subframes is, for example, 1 millisecond.

In the frame, for example, as illustrated in FIG. 4, resources, such as PUCCH, PRACH, SRS, PUSCH, and the like are provided. PUCCH is the abbreviation of a physical uplink control channel, PRACH is the abbreviation of a physical random access channel, SRS is the abbreviation of a sounding reference signal, and PUSCH is the abbreviation of a physical uplink shared channel. In the embodiment, in each of the subframes, the resource that is used for transmission of the urgent information sent from the terminal device 30 is previously allocated in the PUSCH resource. The resource that is previously allocated for the transmission of the urgent information sent from the terminal device 30 is indicated, in FIG. 4, by a reservation area 40 for each of the subframes.

The detail of the reservation area 40 in each of the subframes is such as that illustrated in, for example, FIG. 5. FIG. 5 is a schematic diagram illustrating an example of the reservation area 40 in detail. The reservation area 40 in each of the subframe is, for example, as illustrated in FIG. 5, divided into a plurality of division areas 41-1 to 41-n in the frequency direction. Furthermore, in the following, if there is no need to distinguish among each of the plurality of the division areas 41-1 to 41-n, the division areas 41-1 to 41-n are simply referred to as division area 41.

In the embodiment, each of the division areas 41 is the radio resource that has the time corresponding to several symbols in the time direction and that has the frequency band corresponding to several subcarriers in the frequency direction. In the embodiment, in each of the subframes, a plurality of the division areas 41 that are present in the same time zone is allocated in the frequency; however, as another example, the plurality of the division areas 41 may also be allocated in the frequency direction and the time direction. Each of the division areas 41 is an example of the resource block.

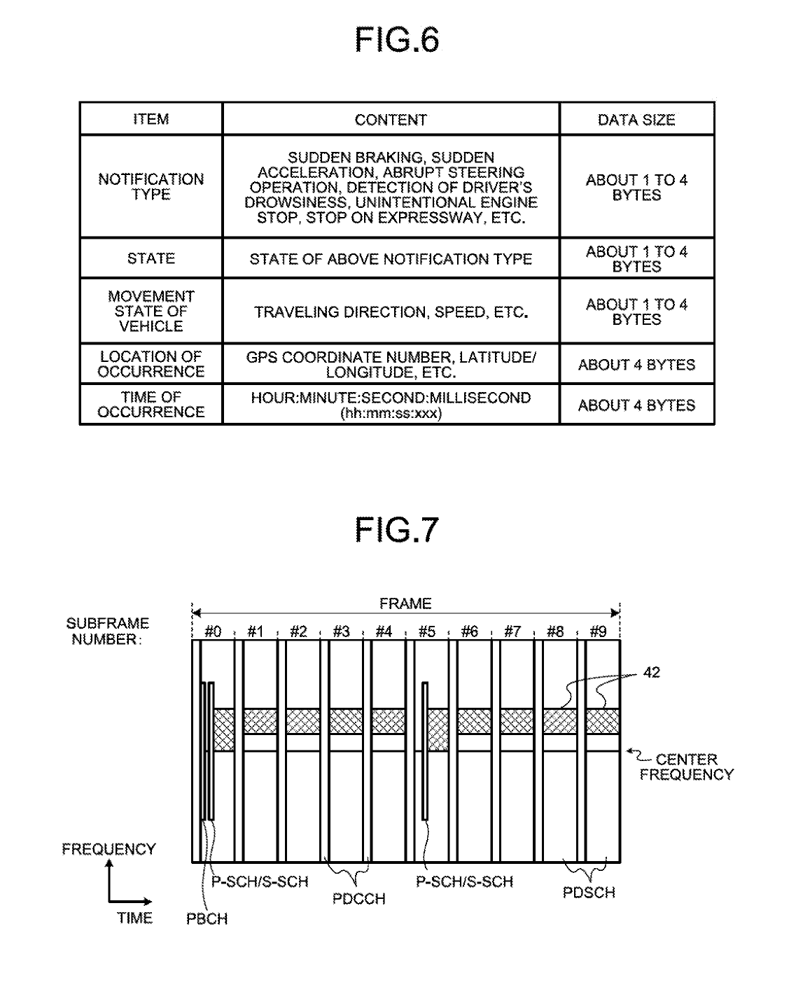

Each of the division areas 41 is allocated to each of the terminal devices 30 in the cell of the RRH 20 for the transmission of the urgent information. Each of the division areas 41 stores therein, for example, data on the urgent information including the information illustrated in FIG. 6. FIG. 6 is a schematic diagram illustrating an example of the urgent information. In the embodiment, the urgent information includes therein, for example, as illustrated in FIG. 6, the information, such as the “notification type”, the “state”, the “movement state of a vehicle”, the “location of occurrence”, and the “time of occurrence”. The “notification type” is information indicating the type of, for example, sudden braking, sudden acceleration, abrupt steering operation, detection of driver's drowsiness, unintentional engine stop, stop on an expressway, or the like. The “state” is information indicating the degree of the type associated with, for example, the “notification type”. The “movement state of a vehicle” is information indicating the movement state of the vehicle when urgent information is generated. The “location of occurrence” is information indicating the location of the vehicle when the urgent information is generated. The “time of occurrence” is the time at which the urgent information occurs.

In the embodiment, the data size of each of the items in the urgent information is about 20 bytes in total at most. Thus, in the embodiment, as each of the division areas 41, the resource with the size that can store therein the data with about at least 20 bytes is secured in the PUSCH resource.

A description will be continued by referring back to FIG. 3. The urgent information processing unit 233 determines whether, regarding each of the resource blocks output from the extracting unit 231, urgent information is included in the resource blocks. If the urgent information is included, the urgent information processing unit 233 creates report information including the urgent information for each resource block. Then, the urgent information processing unit 233 outputs the created report information to the inserting unit 232. Furthermore, if the plurality of the terminal devices 30 transmits urgent information by using the same resource block, the data in the resource block is destroyed due to collision. Consequently, the urgent information processing unit 233 fails to decode the data in the subject resource block. In also a case in which the urgent information processing unit 233 fails to decode the data in the resource block, the urgent information processing unit 233 determines that the urgent information is not included in the resource block.

The inserting unit 232 inserts the report information including the urgent information created by the urgent information processing unit 233 into the resource block that is previously allocated for a report of the urgent information. At this time, the inserting unit 232 inserts the report information including the urgent information that is included in the resource block extracted by the extracting unit 231 into the resource block that is used for the report and that is reported first. Then, the extracting unit 231 performs inverse Fourier transformation on the signal in which the urgent information is inserted in the resource block that is used for the report of the urgent information. Then, the inserting unit 232 outputs the signal that has been subjected to inverse Fourier transformation to the transmitting unit 221. The signal output from the inserting unit 232 is transmitted to the terminal device 30 in the cell by the transmitting unit 221.

In the following, the downlink physical channel transmitted to the terminal device 30 will be described. FIG. 7 is a schematic diagram illustrating an example of arrangement of a physical channel in the downlink. In the downlink, for example, as illustrated in FIG. 7, a single frame is constituted by a plurality of subframes in the time direction. In the embodiment, 10 subframes with the frame numbers of #0 to #9 are included in a single frame. The length of the single frame is, for example, 10 milliseconds and the length of each of the subframes is, for example, 1 millisecond.

In the frame, for example, as illustrated in FIG. 7, resources, such as PBCH, P-SCH/S-SCH, PDCCH, and PDSCH are contained. PBCH is the abbreviation of a physical broadcast channel and P-SCH/S-SCH is the abbreviation of a primary-synchronization channel/secondary-synchronization channel. Furthermore, PDCCH is the abbreviation of a physical downlink control channel and PDSCH is the abbreviation of a physical downlink shared channel.

In the embodiment, in the PDSCH resources in each of the subframes, the resource that is used to report the urgent information to the terminal device 30 in the cell is previously allocated. The resource that is previously allocated for a report of the urgent information to be sent to the plurality of the terminal devices 30 is indicated, in FIG. 7, by a reservation area 42 for each subframe. For example, similarly to the reservation area 40 illustrated in FIG. 5, the reservation area 42 in each of the subframes is divided into the plurality of the division areas 41-1 to 41-n in the frequency direction.

In the embodiment, each of the terminal devices 30 present in the cell of the RRH 20 monitors, in each of the subframes, all of the division areas 41 in the reservation area 42. Consequently, if the inserting unit 232 stores the urgent information in one of the division areas 41, the terminal devices 30 in the cell can acquire the urgent information.

Furthermore, in the RRH 20, the process of identifying and extracting a predetermined resource block from among the resource blocks that are included in the signal transmitted from the terminal device 30 and the process of inserting a predetermined signal into a predetermined resource block in the signal to be transmitted to the terminal device 30 is one of the processes performed in the layer 1. Namely, in the embodiment, the RRH 20 performs the process in the layer 1.

Terminal Device 30

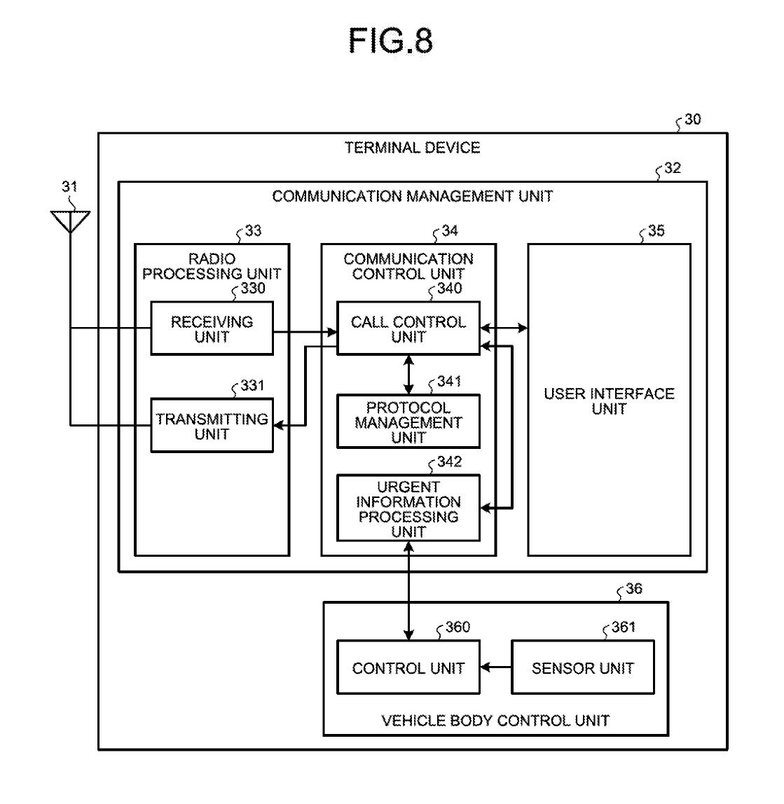

FIG. 8 is a block diagram illustrating an example of the terminal device. The terminal device 30 according to the embodiment acquires the state of the vehicle 2 on which the terminal device 30 is mounted, performs operation control of the subject vehicle 2, notifies the RRH 20 of urgent information, and acquires the urgent information from the RRH 20. The terminal device 30 includes, for example, as illustrated in FIG. 8, a communication management unit 32, a vehicle body control unit 36, and an antenna 31.

The vehicle body control unit 36 acquires the state of the vehicle 2 on which the terminal device 30 is mounted and performs operation control of the vehicle 2. The vehicle body control unit 36 includes a control unit 360 and a sensor unit 361.

The sensor unit 361 monitors the operation state of the vehicle 2, such as the operation of a brake, the speed of the vehicle 2, or the like and acquires the operation information on the vehicle 2. Then, the sensor unit 361 outputs the operation information on the vehicle 2 to the control unit 360. For example, the sensor unit 361 outputs, to the control unit 360, the information on the location, the time, the traveling direction, the speed, the level of the brake, and the like of the vehicle 2 as the operation information on the vehicle 2.

If the operation information on the vehicle 2 is output from the sensor unit 361, the control unit 360 determines, based on the subject operation information, whether autonomous control of the vehicle 2 is performed. If it is determined that autonomous control is performed, the control unit 360 performs autonomous control that controls each of the units in the vehicle 2 in accordance with the operation information on the vehicle 2.

For example, the control unit 360 acquires, from the sensor unit 361, the operation information that includes therein both information on the distance between the vehicle 2 having mounted thereon the terminal device 30 and the other vehicle 2 and speed. Then, if the distance between the vehicles is smaller than a predetermined distance and the speed thereof is equal to or greater than a predetermined speed, the control unit 360 decides to perform control such that a brake is applied. Then, the control unit 360 controls the member that is included in the vehicle 2 and that is related to the brake such that the brake is applied.

Furthermore, if the control unit 360 performs autonomous control, the control unit 360 notifies an urgent information processing unit 342 of the notification of the autonomous control. The control unit 360 may also notify the urgent information processing unit 342 by adding the information acquired from the sensor unit 361 to the operation information on autonomous control.

At this point, in the embodiment, every time the control unit 360 performs the autonomous control, the control unit 360 sends a notification to the urgent information processing unit 342 and allows the urgent information processing unit 342 to start notifying the urgent information; however, the control unit 360 may also determines the notification of the urgent information, in addition to the execution of the autonomous control. For example, the control unit 360 may also determine whether a notification of the urgent information is sent based on the control of the vehicle 2 and may also notify the urgent information processing unit 342 of the urgent information based on the subject determination result. For example, if a brake with the intensity equal to or greater than that previously defined based on the autonomous control is applied to the vehicle 2, the control unit 360 may also notify the urgent information processing unit 342 of the notification of the urgent information.

Furthermore, for example, the control unit 360 may also decide to perform notification of the urgent information by using the acquired operation information on the vehicle 2 independent of the execution of the autonomous control. For example, if the speed of the vehicle 2 acquired from the sensor unit 361 exceeds a predetermined speed and if the level of the brake exceeds a predetermined intensity of the brake, the control unit 360 may also notify the urgent information processing unit 342 of the urgent information.

Furthermore, if the information on the autonomous control is output from the urgent information processing unit 342, the control unit 360 controls each of the units in the vehicle 2 based on the information on the subject autonomous control.

The communication management unit 32 transmits and receives the urgent information. The communication management unit 32 includes a radio processing unit 33, a communication control unit 34, and a user interface unit 35.

The user interface unit 35 includes an output device, such as a liquid crystal monitor, or the like, and includes an input device, such as a touch panel, or the like. The user interface unit 35 outputs, to the communication control unit 34, the information that is input from a user via the input device. Furthermore, the user interface unit 35 outputs the information output from the communication control unit 34 to the output device.

The radio processing unit 33 is an interface for radio communication with the RRH 20. The radio processing unit 33 includes a receiving unit 330 and a transmitting unit 331.

The receiving unit 330 receives a radio signal that is output from the RRH 20 via the antenna 31. Then, the receiving unit 330 generates a baseband reception signal by performing a process of amplification, down-conversion, and the like on the received signal. Then, the receiving unit 330 outputs the generated baseband reception signal to the communication control unit 34.

The transmitting unit 331 generates a signal having the RF band by performing the process of up-conversion, amplification, and the like on the baseband signal output from the communication control unit 34. Then, the transmitting unit 331 transmits the generated signal having the RF band to the RRH 20 via the antenna 31.

The communication control unit 34 includes a call control unit 340, a protocol management unit 341, and the urgent information processing unit 342. The call control unit 340 performs a process in the layer 1 to the layer 3 in communication with the BBU 10 via the RRH 20. For example, by using previously set call setting, the call control unit 340 performs overall control of a call process related to radio communication, such as control of communication resource, that is used for communication with the BBU 10 via the RRH 20.

Furthermore, the call control unit 340 extracts, from among the resource blocks included in the signal received from the RRH 20, both the resource block that is previously allocated for a report of the urgent information and a resource block that stores therein the data that is addressed to the own device and that is other than the urgent information. The call control unit 340 outputs, to the urgent information processing unit 342, the extracted resource block that is used for the report of the urgent information. The resource block used, in a downlink, for the report of the urgent information is arranged in, for example, as described with reference to FIG. 7, the reservation area 42 in each of the subframes. Furthermore, the call control unit 340 performs a process based on the data in the resource block that stores therein the data that is addressed to the own device and that is other than the urgent information and then outputs the execution result to the user interface unit 35.

Furthermore, the call control unit 340 performs a predetermined process on the information from a user via the user interface unit 35 and inserts the processed data into the resource block that is allocated to the own device and that is used to transmit data other than the urgent information. Furthermore, if the urgent information is output from the urgent information processing unit 342, the call control unit 340 inserts the subject urgent information into the resource block that is allocated to the own device and that is used to transmit the urgent information. The signal in which the urgent information and data other than the urgent information are inserted into the predetermined resource blocks by the call control unit 340 is output to the transmitting unit 331 and is transmitted to the RRH 20 by the transmitting unit 331. The resource block, in the uplink, that is used to transmit the urgent information is provided in, for example, as described with reference to FIG. 4, the reservation area 40 in each of the subframes. In the reservation area 40 in each of the subframes, the information in the division areas 41 that are allocated to the own device is notified from the BBU 10 via the RRH 20.

When the protocol management unit 341 establishes a connection with the BBU 10 via the RRH 20, the protocol management unit 341 determines the content of the signal received from the BBU 10 via the RRH 20. Then, the protocol management unit 341 performs a process, such as generating a signal, or the like, in accordance with the protocol corresponding to the content of the determined signal. For example, the protocol management unit 341 generates, in the procedure of the random access, a signal, such as a RACH preamble, an RRC connection request, or the like, and then outputs the generated signal to the call control unit 340.

The urgent information processing unit 342 receives a notification of the autonomous control from the control unit 360. In the notification of the autonomous control, information on, for example, the time of sudden braking, the traveling direction, the speed, the level of the braking, and the like are included. The urgent information processing unit 342 creates urgent information from the information that is included in the notification of the autonomous control acquired from the control unit 360. The urgent information processing unit 342 contains, in the created urgent information, as the identification information on the terminal device 30 that is the transmission source, the identification information on the own device. Then, the urgent information processing unit 342 transmits the created urgent information to the base station 6 by using the resource block that is previously allocated to the own device and that is used to transmit the urgent information. Specifically, the urgent information processing unit 342 outputs the created urgent information to the call control unit 340. The call control unit 340 inserts the urgent information output from the urgent information processing unit 342 into the resource block that is allocated to the own device used for transmission of the urgent information. The signal in which the data on the urgent information is inserted into the predetermined resource block by the call control unit 340 is output to the transmitting unit 331 and is transmitted to the base station 6 by the transmitting unit 331.

Furthermore, if the data in the resource block for a report of the urgent information is output from the call control unit 340, the urgent information processing unit 342 determines, for each resource block, whether the urgent information is included in the data in the resource block. If the urgent information is included in the data in the resource block, the urgent information processing unit 342 refers to the identification information that is related to the terminal device 30 functioning as the transmission source and that is included in the urgent information and determines whether the subject urgent information is the urgent information that has transmitted from the own device. If the urgent information is the urgent information transmitted from the own device, the urgent information processing unit 342 discards the urgent information. In contrast, if the urgent information is not the urgent information transmitted from the own device, the urgent information processing unit 342 decides the autonomous control that is performed in response to the urgent information. Then, the urgent information processing unit 342 outputs the information on the decided autonomous control to the control unit 360.

### Process Performed in the Radio Communication System 1

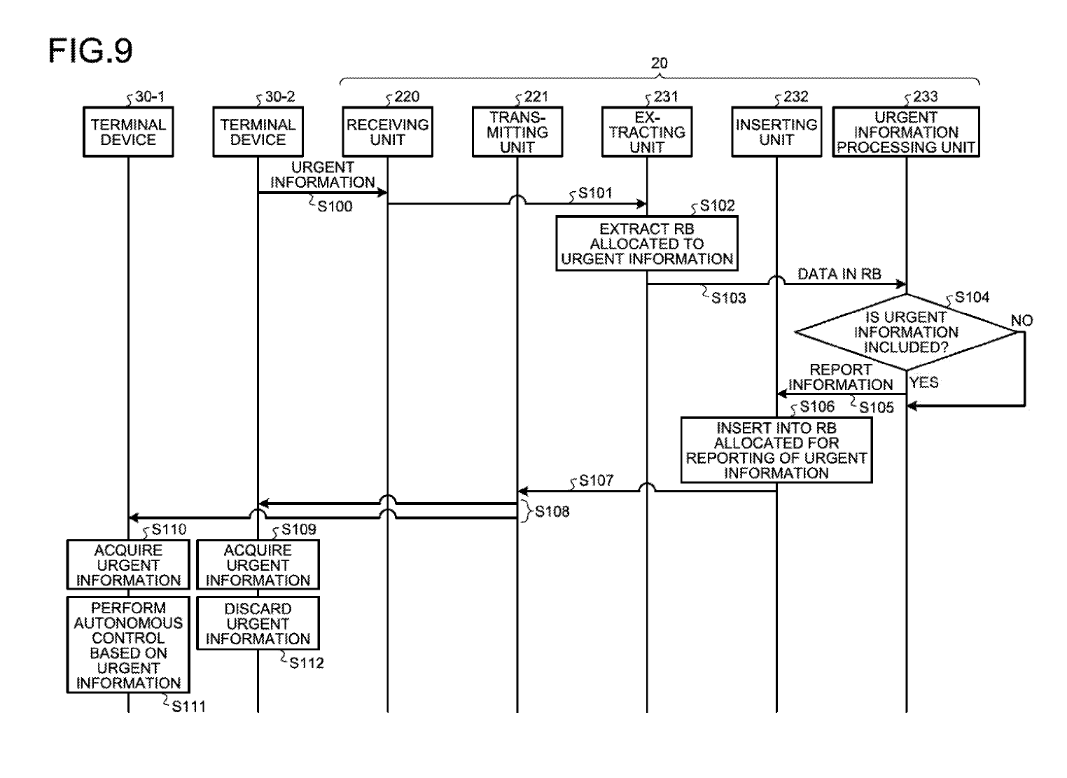

In the following, the flow of the distribution of the urgent information performed by the radio communication system 1 will be described with reference to FIG. 9. FIG. 9 is a sequence diagram illustrating an example of a process performed in the radio communication system 1.

First, in the vehicle 2 on which a terminal device 30-2 is mounted, autonomous control is operated and the urgent information is transmitted (Step S100). The receiving unit 220 in the RRH 20 performs a predetermined process, such as amplification, down-conversion, or the like, on the signal received from the terminal device 30-2 and then outputs the processed signal to the extracting unit 231 (Step S101).

The extracting unit 231 extracts, from among the resource blocks included in the signal output from the receiving unit 220, the resource block (RB) allocated for transmission of the urgent information (Step S102). Then, the extracting unit 231 outputs the extracted RB used for the transmission of the urgent information to the urgent information processing unit 233 (Step S103).

Regarding each of the RBs output from the extracting unit 231, the urgent information processing unit 233 determines whether the urgent information is included in the RB (Step S104). If the urgent information is not included in any of the RBs (No at Step S104), the urgent information processing unit 233 discards the data in the RB.

In contrast, if the urgent information is included in the RB (Yes at Step S104), the urgent information processing unit 233 creates report information that includes therein the urgent information. Then, the urgent information processing unit 233 outputs the created report information to the inserting unit 232 (Step S105). The inserting unit 232 inserts the report information that includes therein the urgent information created by the urgent information processing unit 233 into the RB that is previously allocated for a report of the urgent information (Step S106). Then, the inserting unit 232 outputs, to the transmitting unit 221, the signal in which the report information including the urgent information is inserted into the RB that is used to report the urgent information (Step S107). The transmitting unit 221 reports, to the terminal device 30 in the cell, the signal in which the report information that includes therein the urgent information is inserted into the RB by the inserting unit 232 (Step S108).

A terminal device 30-1 and the terminal device 30-2 monitor, in the downlink, the resource for a report of the urgent information and then acquire the urgent information reported from the RRH 20 (Steps S109 and S110). The terminal device 30-1 performs autonomous control on the vehicle 2 based on the acquired urgent information (Step S111). In contrast, the terminal device 30-2 does not perform autonomous control based on the acquired urgent information because the identification information on the own device is included in the acquired urgent information, the terminal device 30-2 discards the subject urgent information (Step S112).

Process Performed in the Terminal Device 30 when Urgent Information is Transmitted

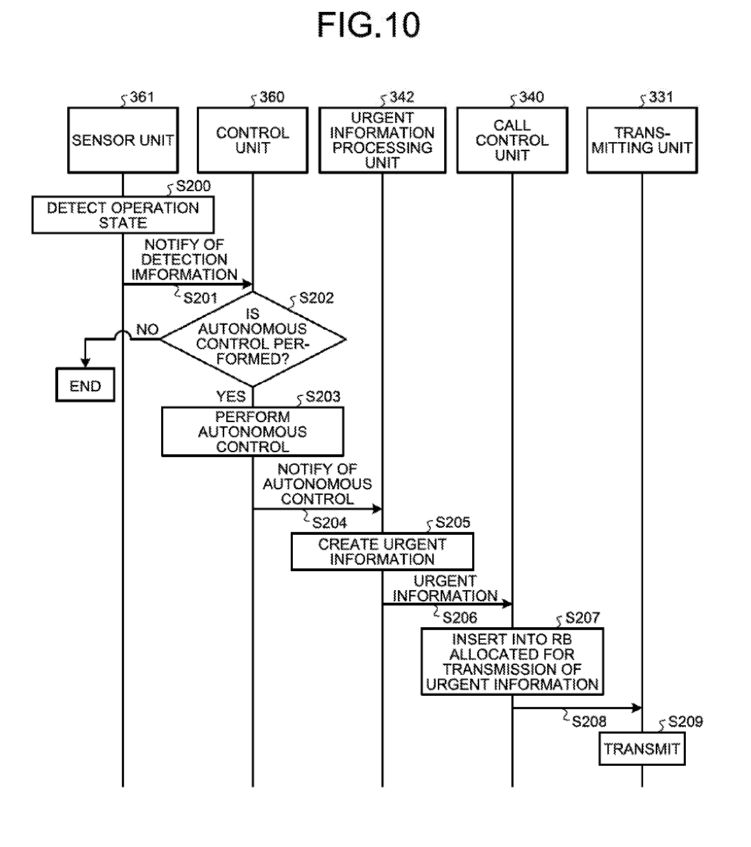

FIG. 10 is a sequence diagram illustrating an example of a process performed in the terminal device 30 when the urgent information is transmitted

The sensor unit 361 detects the operation state of the vehicle 2 on which the terminal device 30 is mounted (Step S200). Then, the sensor unit 361 notifies the control unit 360 of the operation information on the vehicle 2 as detection information (Step S201). The control unit 360 determines, based on the detection information notified from the sensor unit 361, whether autonomous control is performed on the vehicle 2 (Step S202). If autonomous control is not performed (No at Step S202), the terminal device 30 ends the process of transmitting the urgent information.

In contrast, if autonomous control is performed (Yes at Step S202), the control unit 360 performs autonomous control on the vehicle 2 (Step S203). Then, the control unit 360 outputs a notification of autonomous control to the urgent information processing unit 342 (Step S204).

The urgent information processing unit 342 creates, based on the notification of the autonomous control output from the control unit 360, the urgent information that includes therein the identification information on the terminal device 30 that is the transmission source (Step S205). Then, the urgent information processing unit 342 outputs the created urgent information to the call control unit 340 (Step S206). The call control unit 340 inserts the urgent information output from the urgent information processing unit 342 into the RB that is allocated to the own device and that is used to transmit the urgent information (Step S207). The call control unit 340 outputs, to the transmitting unit 331, the signal in which the urgent information is inserted into the predetermined RB (Step S208). The transmitting unit 331 transmits the signal output from the call control unit 340 to the RRH 20 via the antenna 31 (Step S209).

Process Performed in the Terminal Device 30 when the Urgent Information is Received

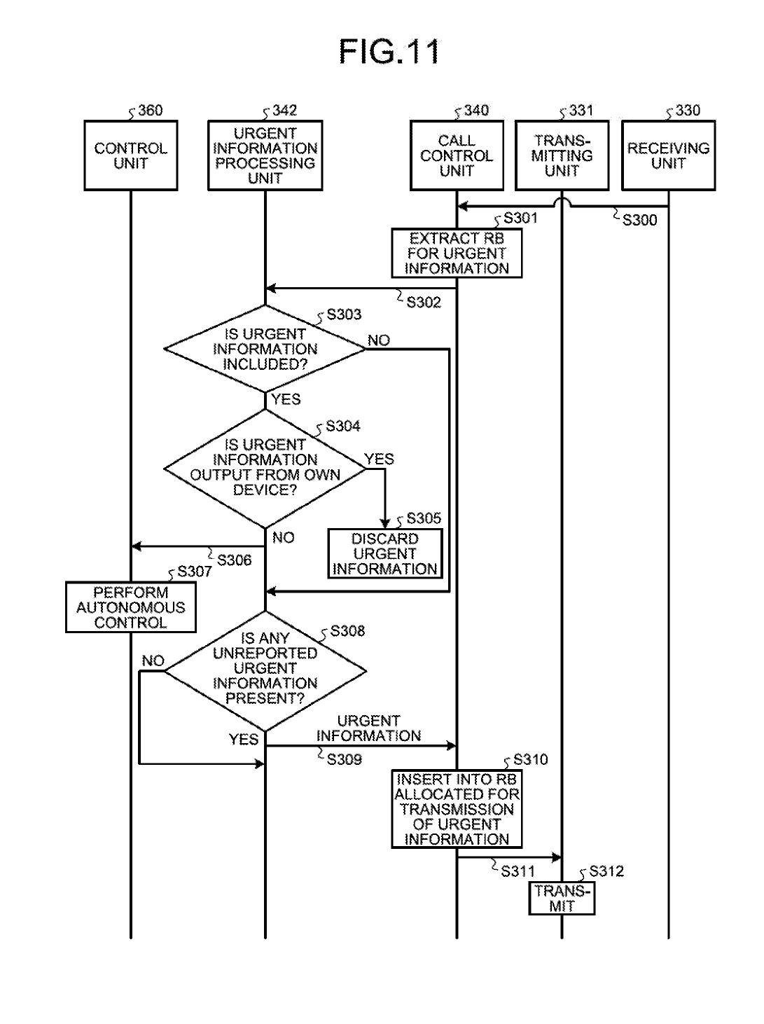

FIG. 11 is a sequence diagram illustrating an example of a process performed in the terminal device 30 when the urgent information is received.

The receiving unit 330 receives the signal output from the RRH 20 via the antenna 31; performs a process, such as amplification, down-conversion, and the like; and outputs the processed signal to the call control unit 340 (Step S300). The call control unit 340 extracts, from among the resource blocks included in the signal received from the RRH 20, the RB that is previously allocated for a report of the urgent information (Step S301). Then, the call control unit 340 outputs, to the urgent information processing unit 342, the extracted RB that is used to report the urgent information (Step S302).

The urgent information processing unit 342 determines whether the urgent information is included in the RB that is output from the call control unit 340 (Step S303). If the urgent information is not included (No at Step S303), the urgent information processing unit 342 performs the process indicated at Step S308. In contrast, if the urgent information is included (Yes at Step S303), the urgent information processing unit 342 refers to the identification information that is related to the terminal device 30 corresponding to the transmission source and that is included in the urgent information and then determines whether the subject urgent information is the urgent information transmitted from the own device (Step S304). If the urgent information is the urgent information transmitted from the own device (Yes at Step S304), the urgent information processing unit 342 discards the urgent information (Step S305) and ends the process.

In contrast, if the urgent information is not the urgent information transmitted from the own device (No at Step S304), the urgent information processing unit 342 decides autonomous control that is performed in response to the urgent information. Then, the urgent information processing unit 342 outputs the information on the decided autonomous control to the control unit 360 (Step S306). The control unit 360 performs, based on the information on the autonomous control notified from the urgent information processing unit 342, autonomous control that controls each of the units in the vehicle 2 (Step S307).

Then, the urgent information processing unit 342 determines whether the urgent information that is not reported is present in the urgent information that has been transmitted by the own device (Step S308). If the urgent information that has not been reported is not present (No at Step S308), the urgent information processing unit 342 ends the process.

In contrast, if the urgent information that has not been reported is present (Yes at Step S308), the urgent information processing unit 342 outputs, to the call control unit 340, the urgent information that has not been reported (Step S309). The call control unit 340 inserts the urgent information output from the urgent information processing unit 342 into the RB that is allocated to the own device and that is used to transmit the urgent information (Step S310). The call control unit 340 outputs, to the transmitting unit 331, the signal in which the urgent information is inserted into the predetermined RB (Step S311). The transmitting unit 331 transmits the signal output from the call control unit 340 to the RRH 20 via the antenna 31 (Step S312).

Process Performed when a Collision Occurs in Urgent Information

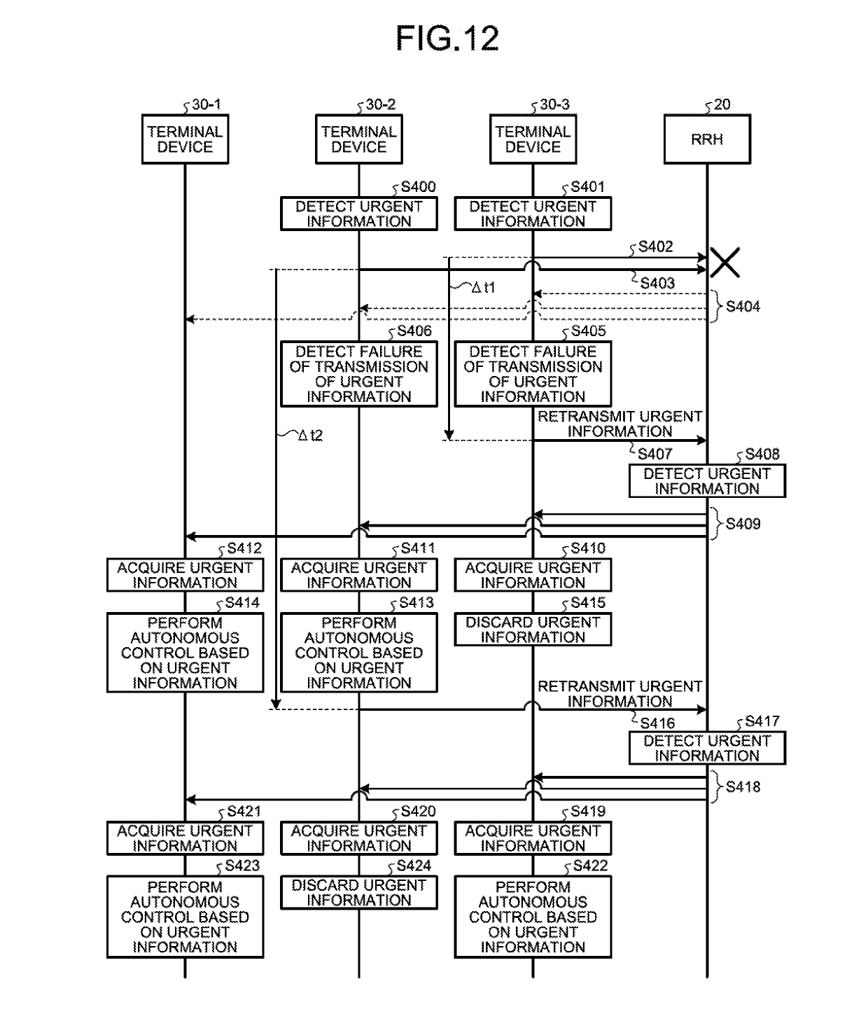

FIG. 12 is a sequence diagram illustrating an example of a process performed in the radio communication system 1 when a collision occurs in urgent information. In FIG. 12, it is assumed of a case in which, in the terminal devices 30-1 to 30-3 mounted on the plurality of respective vehicles 2, the terminal device 30-2 and the terminal device 30-3 have sent the urgent information by using the same resource block. The terminal devices 30-1 to 30-3 are present in the cell in the RRH 20.

First, The terminal device 30-2 and the terminal device 30-3 detect that the urgent information has been generated (Steps S400 and S401). Then, the terminal device 30-2 and the terminal device 30-3 transmit the urgent information to the RRH 20 by using the same RB that is allocated, in the uplink, for a report of the urgent information (Steps S402 and S403). A collision occurs, in the same RB, in each of the pieces of the urgent information transmitted by the respective terminal device 30-2 and the terminal device 30-3 and thus the data is destroyed. Thus, in the RRH 20, the pieces of the urgent information transmitted from the terminal device 30-2 and the terminal device 30-3 are not properly received. Consequently, in the RB that is used to report the urgent information in the downlink, both the urgent information transmitted from the terminal device 30-2 and the urgent information transmitted from the terminal device 30-3 are not stored (Step S404).

The terminal device 30-2 and the terminal device 30-3 detect that transmission of the urgent information has failed by referring to the RB used for the report of the urgent information in the downlink and by detecting that the urgent information transmitted from the own device is not reported (Steps S405 and S406). Each of the terminal device 30-2 and the terminal device 30-3 retransmits the urgent information after elapse of random time since the transmission of the urgent information.

For example, the terminal device 30-3 retransmits, in the uplink, the urgent information by using the RB allocated for the report of the urgent information after elapse of random time Δt1 since the transmission of the urgent information performed at Step S402 (Step S407). The RRH 20 detects the urgent information transmitted from the terminal device 30-3 (Step S408). Then, the RRH 20 reloads the detected urgent information to the RB used for the report of the urgent information in the downlink and then reports to the terminal devices 30-1 to 30-3 located in the cell (Step S409).

The terminal devices 30-1 to 30-3 refer to the RB used for the report of the urgent information in the downlink and acquire the urgent information (Steps S410, S411, and S412). The terminal devices 30-1 and 30-2 detect that the reported urgent information is not the urgent information transmitted from the respective own devices and perform autonomous control on the respective vehicles 2 based on the urgent information (Steps S413 and S414). In contrast, the terminal device 30-3 detects that the reported urgent information is the urgent information transmitted from the own device and discards the acquired urgent information (Step S415).

Furthermore, for example, the terminal device 30-2 retransmits the urgent information by using the RB that is allocated for the report of the urgent information in the uplink after elapse of random time Δt2 since the transmission of the urgent information performed at Step S403 (Step S416). The RRH 20 detects the urgent information transmitted from the terminal device 30-2 (Step S417). Then, the RRH 20 reloads the detected urgent information to the RB used for reporting the urgent information in the downlink and reports to the terminal devices 30-1 to 30-3 in the cell (Step S418).

The terminal devices 30-1 to 30-3 refer to the RB used for the report of the urgent information in the downlink and then acquire the urgent information (Steps S419, S420, and S421). The terminal devices 30-1 and 30-3 detect that the detected urgent information is not the urgent information transmitted from the own device and perform autonomous control on each of the vehicles 2 based on the urgent information (Steps S422 and S423). In contrast, the terminal device 30-2 detects that the reported urgent information is the urgent information transmitted from the device and discards the acquired urgent information (Step S424).

Hardware

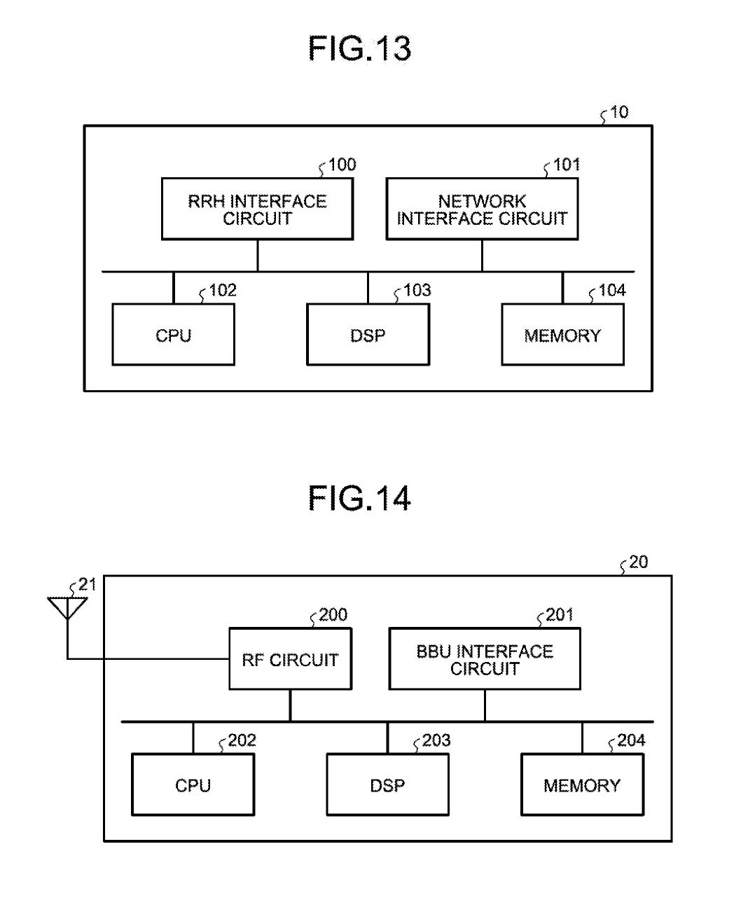

FIG. 13 is a schematic diagram illustrating an example of hardware of the BBU 10. The BBU 10 includes, for example, as illustrated in FIG. 13, a RRH interface circuit 100, a network interface circuit 101, a central processing unit (CPU) 102, a digital signal processor (DSP) 103, and a memory 104.

The CPU 102 and the DSP 103 are connected to the RRH interface circuit 100, the network interface circuit 101, and the memory 104 via a bus. The RRH interface circuit 100 implements the function of, for example, the RRH interface unit 11 illustrated in FIG. 2. Furthermore, the network interface circuit 101 implements the function of, for example, the network interface unit 13 illustrated in FIG. 2.

The memory 104 stores therein programs for implementing the function of, for example, the communication control unit 12 illustrated in FIG. 2. By reading the programs stored in the memory 104 from the memory 104 and executing the read programs, the CPU 102 cooperates with the DSP 103 and implements the function of, for example, the communication control unit 12 illustrated in FIG. 2, i.e., the function of the call control unit 120 and the protocol management unit 121.

FIG. 14 is a schematic diagram illustrating an example of hardware of the RRH 20. The RRH 20 includes, for example, as illustrated in FIG. 14, an RF circuit 200, a BBU interface circuit 201, a CPU 202, a DSP 203, a memory 204, and the antenna 21.

The CPU 202 and the DSP 203 are connected to the RF circuit 200, the BBU interface circuit 201, and the memory 204 via a bus. The RF circuit 200 implements the function of, for example, the radio processing unit 22 illustrated in FIG. 3. Furthermore, the BBU interface circuit 201 implements the function of, for example, the BBU interface unit 24 illustrated in FIG. 3.

The memory 204 stores therein programs for implementing the function of, for example, the communication control unit 23 illustrated in FIG. 3. By reading the programs stored in the memory 204 from the memory 204 and executing the read programs, the CPU 202 cooperates with the memory 204 and implements the function of, for example, the communication control unit 23 illustrated in FIG. 3, i.e., the function of the extracting unit 231, the inserting unit 232, and the urgent information processing unit 233.

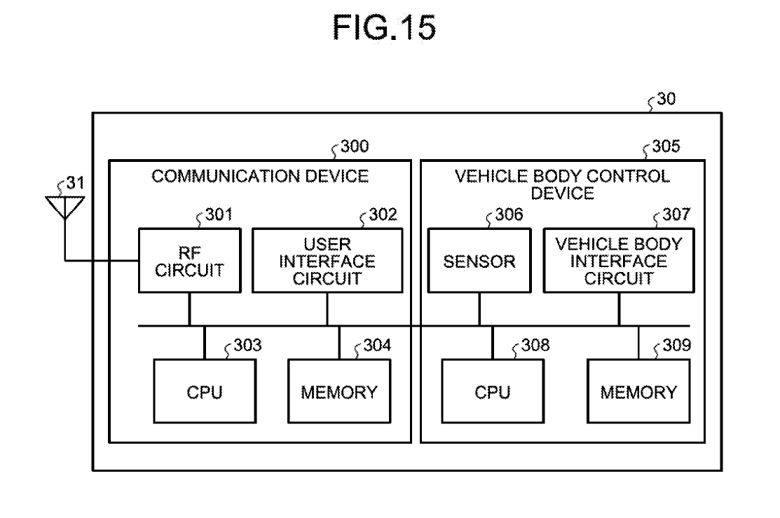

FIG. 15 is a schematic diagram illustrating an example of hardware of the terminal device 30. The terminal device 30 includes, for example, as illustrated in FIG. 15, a communication device 300, a vehicle body control device 305, and the antenna 31. The communication device 300 implements, for example, the function of the communication management unit 32 illustrated in FIG. 8. Furthermore, the vehicle body control device 305 implements the function of, for example, the vehicle body control unit 36 illustrated in FIG. 8.

The communication device 300 includes, for example, as illustrated in FIG. 15, an RF circuit 301, a user interface circuit 302, a CPU 303, and a memory 304. The RF circuit 301 implements the function of, for example, the radio processing unit 33 illustrated in FIG. 8, i.e., the function of the receiving unit 330 and the transmitting unit 331. The user interface circuit 302 is, for example, an input device, such as a touch panel, or the like or an output device, such as a liquid crystal monitor, or the like and implements the function of, for example, the user interface unit 35 illustrated in FIG. 8.

The memory 304 stores therein programs for implementing the function of, for example, the communication control unit 34 illustrated in FIG. 8. By reading the programs stored in the memory 304 from the memory 304, the CPU 303 implements the function of, for example, the communication control unit 34 illustrated in FIG. 8, i.e., the function of the call control unit 340, the protocol management unit 341, and the urgent information processing unit 342.

The vehicle body control device 305 includes, for example, as illustrated in FIG. 15, a sensor 306, a vehicle body interface circuit 307, a CPU 308, and a memory 309. The sensor 306 includes, for example, a velocity sensor, a distance sensor, a GPS sensor, or the like. The sensor 306 implements, for example, the function of the sensor unit 361 illustrated in FIG. 8. The vehicle body interface circuit 307 is an interface for connecting each of the unit in the vehicle 2 to the CPU 308.

The memory 309 stores therein programs for implementing the function of, for example, the control unit 360 illustrated in FIG. 8. By reading the programs stored in the memory 309 from the memory 309, the CPU 308 implements the function of, for example, the control unit 360 illustrated in FIG. 8.

### Effect of the Embodiment

As described above, the RRH 20 according to the embodiment includes the extracting unit 231, the urgent information processing unit 233, and the inserting unit 232. The extracting unit 231 extracts, from among the resource blocks included in the signal received from the terminal device 30, the resource block that is previously allocated for transmission of urgent information. The urgent information processing unit 233 determines whether the urgent information is included in the resource block extracted by the extracting unit 231. If the urgent information is included in the resource block extracted by the extracting unit 231, the urgent information processing unit 233 creates report information that includes therein the urgent information included in the resource block extracted by the extracting unit 231. The inserting unit 232 inserts the report information that includes therein the urgent information and that is created by the urgent information processing unit 233 into the resource block that is previously allocated for the transmission of the urgent information. Consequently, the RRH 20 can convey the information that has high urgency and that has been sent from the certain terminal device 30 to the other terminal device 30 in a low delay.

For example, if the vehicle 2 is traveling at 40 km per hour, the vehicle 2 moves forward about 11 m per second. Thus, the distance between before and after the plurality of the vehicles 2 traveling at 40 km per hour is, for example, 3 to 5 m, the reaction velocity equal to or less than 500 ms is needed to avoid a collision due to autonomous control. If the terminal device 30 mounted on the vehicle 2 performs communication with the data server 5 via the communication network 4, such as the Internet, or the like, in general, it is conceivable that a response is sent back in the order close to in units of seconds. Furthermore, if congestion occurs in the communication network 4, the delay time thereof varies and it is difficult to guarantee a response in a short period. Thus, if information is reported via the data server 5, it is difficult to avoid the collision due to the autonomous control under the condition described above.

Furthermore, regarding the autonomous control performed based on the operation detection of the sensor mounted on the vehicle 2, it is conceivable that time is needed in the order of 100 milliseconds. Here, with the radio communication system 1 according to the embodiment, the transmission period of the report information between the radio sections is performed in units of subframes (for example, in units of 1 millisecond). Thus, even if the time period of the process of reloading the signal performed by the RRH 20 is added, the RRH 20 can report the information to the other terminal devices 30 in the order of several tens of milliseconds. Consequently, even if the processing time that is in the order of 100 milliseconds due to the autonomous control described above is added to the transmission period of the report information in the radio communication system 1 according to the embodiment, the processing time is sufficiently within the reaction velocity described above. Furthermore, because the urgent information is turned back at the RRH 20, a delay factor due to congestion or the like in the communication network 4 is not present and fluctuation of delay time is not also present, whereby it is possible to securely report the information in a short period of time and it is possible to implement highly reliable automated operation.

Furthermore, in the embodiment described above, a plurality of resource blocks each having a different frequency band is allocated, in the same time zone, for the transmission of the urgent information sent from the terminal device 30. Furthermore, a plurality of the resource blocks each having a different frequency band is previously allocated, in the same time zone, for a report of the urgent information. Consequently, it is possible to prevent a collision of the urgent information transmitted by the plurality of the terminal devices 30 in a short period of time.

Furthermore, in the embodiment described above, if the urgent information is included in the resource block that is extracted by the extracting unit 231, the inserting unit 232 inserts the report information that includes therein the urgent information included in the resource block extracted by the extracting unit 231 into the resource block used for a report that is reported first. Consequently, the RRH 20 can convey the information that has high urgency and that is transmitted from the certain terminal device 30 by using the other terminal device 30 in a low delay.

Furthermore, in the embodiment described above, a plurality of resource blocks is allocated, in each of the subframes, for each combination of the time zone and the frequency band, in order to use for transmission of the urgent information received from the terminal device 30. Furthermore, the BBU 10 allocates, in each of the subframes, the resource block that is used for transmission of the urgent information and that is allocated to each of the terminal devices 30 located within the range of the RRH 20 to each of the terminal devices 30 such that the number of terminal devices 30 that uses the same resource block becomes small. Consequently, it is possible to prevent a collision of the urgent information transmitted in a short time period by the plurality of the terminal devices 30.

Others

The technology disclosed in the present application is not limited to the embodiments described above and various modifications are possible as long as they do not depart from the spirit of the present application.

For example, in the embodiment described above, information used for autonomous control of the vehicle 2 has been described as the urgent information; however, the disclosed technology is not limited to this. For example, the information is not used for autonomous control of the vehicle 2 as long as the information is used, based on the information transmitted from the certain terminal device 30, by the other terminal device 30 for a system that performs a process in a short period of time.

Furthermore, in the embodiment described above, the RRH 20 turns back the urgent information transmitted from the terminal device 30, whereby the information is conveyed to the plurality of the terminal devices 30 in the cell in the RRH 20 in a short period of time; however, the disclosed technology is not limited to this. For example, in addition to turning back the urgent information transmitted from the terminal device 30 at the RRH 20, the subject information may also be transferred to the other RRH 20 via the BBU 10. Consequently, the urgent information transmitted from the terminal device 30 that is located in the cell in the certain RRH 20 is also conveyed to the terminal device 30 located in the cell in the other RRH 20. Consequently, it is possible to convey the urgent information transmitted from the certain terminal device 30 to the terminal device 30 located in a wider area.

Furthermore, in the embodiment described above, the execution of autonomous control performed by the vehicle 2 has been described as an example of a trigger for the generation of the urgent information; however, the disclosed technology is not limited to this. In addition to the execution of autonomous control, for example, the urgent information may also be transmitted to the base station 6 by the terminal device 30 in each of the vehicles 2 as a trigger when the sensor 306 detects an excessive brake operation performed by humans.

Furthermore, for example, in addition to turning the urgent information transmitted from the terminal device 30 back at the RRH 20, it may also be possible to transfer, via the data server 5, the subject urgent information to each of the RRHs 20 connected to the other BBU 10 and convey the subject urgent information to the terminal devices 30 located in the cell in each of the RRHs 20. Consequently, the urgent information transmitted from the terminal device 30 is also conveyed to the other terminal device 30 that is away from the subject terminal device 30. In the terminal device 30 located away from the terminal device 30 that is the transmission source of the urgent information, there is little need to perform control based on the urgent information in a short period of time. However, this type of terminal device 30 can efficiently use the conveyed urgent information for the movement of the vehicle 2 in accordance with the content of the urgent information, such as selecting an alternate routing of the location of the generation of the urgent information.

Furthermore, in the embodiment described above, the BBU 10 allocates the resource block for transmission of the urgent information in the uplink to each of the terminal devices 30 located in the cell in the RRH 20; however, the disclosed technology is not limited to this. For example, each of the terminal devices 30 may also randomly select, based on the identification information or the like allocated to the own device, the resource block that is used by the own device to transmit the urgent information from among the resource blocks used for the transmission of the urgent information in the uplink. Consequently, the processing load of the BBU 10 can be reduced.

According to an aspect of an embodiment of the radio device, the base station, and the terminal device disclosed in the present application, it is possible to transmit information having high urgency and being transmitted from a certain terminal device to another terminal device in a low delay.

All examples and conditional language recited herein are intended for pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although the embodiment of the present invention has been described in detail, it should be understood that the various changes, substitutions, and alterations could be made hereto without departing from the spirit and scope of the invention.

What is claimed is:

1. A Radio device used in a base station that includes the radio device and a radio control device, the radio device comprising:
an extracting unit that extracts a resource block, from among resource blocks included in a signal received from a terminal device, that is previously allocated for transmission of urgent information;
an urgent information processing unit that creates, when the urgent information is included in the resource block extracted by the extracting unit, report information including the urgent information that is included in the resource block extracted by the extracting unit; and
an inserting unit that inserts the report information including the urgent information created by the urgent information processing unit into a resource block that is previously allocated for a report of the urgent information.

2. The radio device according to claim 1, wherein
a plurality of resource blocks with different frequency bands is previously allocated, in the same time zone, for the transmission of the urgent information received from the terminal device, and
a plurality of resource blocks with different frequency bands is previously allocated, in the same time zone, for the report of the urgent information.

3. The radio device according to claim 1, wherein, when the urgent information is included in the resource block extracted by the extracting unit, the inserting unit inserts the report information including the urgent information included in the resource block extracted by the extracting unit into the resource block that is used for the report and that is reported first.

4. A base station comprising:
at least one radio device; and
a radio control device, wherein
the at least one radio device includes
an extracting unit that extracts a resource block, from among resource blocks included in a signal received from a terminal device, that is previously allocated for transmission of urgent information,
an urgent information processing unit that creates, when the urgent information is included in the resource block extracted by the extracting unit, report information including the urgent information that is included in the resource block extracted by the extracting unit, and
an inserting unit that inserts the report information including the urgent information created by the urgent information processing unit into a resource block that is previously allocated for a report of the urgent information.

5. The base station according to claim 4, wherein
for each combination of a time zone and a frequency band, a plurality of resource blocks is previously allocated, in each of subframes, for transmission of the urgent information received from the terminal device,
the at least one radio device comprises a plurality of radio devices, and
the radio control device allocates to each of the plurality of radio devices, in each of the subframes, a resource block that is used for the transmission of the urgent information by each of the terminal devices located within the range of each of the radio devices such that that number of terminal devices allocated to the same resource block can be reduced.

6. The base station according to claim 4, wherein
a plurality of resource blocks with different frequency bands is previously allocated, in the same time zone, for the transmission of the urgent information received from the terminal device, and
a plurality of resource blocks with different frequency bands is previously allocated, in the same time zone, for the report of the urgent information.

7. The base station according to claim 4, wherein, when the urgent information is included in the resource block extracted by the extracting unit, the inserting unit inserts the report information including the urgent information included in the resource block extracted by the extracting unit into the resource block that is used for the report and that is reported first.

8. A terminal device that communicates with a base station, the terminal device comprising:
an urgent information processing unit that transmits, when urgent information is generated, the urgent information to the base station by using a resource block that is previously allocated to the terminal device for transmission of the urgent information and that outputs, when the urgent information that is inserted into the resource block that is previously allocated for a report of the urgent information is received from the base station, the urgent information.
